(19) United States
(12) Patent Application Publication
(10) Pub. No.: US 2005/0110387 A1
(43) Pub. Date: May 26, 2005

(54) Photoluminescent sleeve for electric lamps for producing a non-electrical light emitting source

(75) Inventor: Kimberly Landry, Coquitlam (CA)

Correspondence Address: DiPINTO & SHIMOKAJI, P.C.;Suite 480, 1301 Dove Street, Newport Beach, CA, 92660, US

(73) Assignee: Luna Technologies International, Inc., Coquitlam (CA)

(21) Appl. No.: 10/723,549

(22) Filed: Nov. 25, 2003

(51) Int. Cl. H01J 63/04; H01J 5/48

(52) U.S. Cl. 313/489; 313/318.01

(57) ABSTRACT

An electric lamp may be designed as a reliable and inexpensive secondary source of light when electric power to the electric lamp is lost. A nearly transparent photoluminescent sleeve may be extruded or injection molded from clear thermoplastic materials containing photoluminescent pigments. This sleeve is then fit around the electric lamp. Radiant energy from the electrical lamp is stored in the sleeve during normal operation of the electric lamp. When the electric lamp is extinguished, the photoluminescent sleeve reradiates light by photoluminescence for many days. Novel linear path marking systems may be developed by fitting a series of electric lamps, for example, along the length of the exit path, with a photoluminescent sleeve that may then be used as a secondary source of light when the electric lamp is extinguished due to a power disruption.

### BACKGROUND OF THE INVENTION

The present invention generally relates to a nearly transparent photoluminescent sleeve extruded or injection molded from clear thermoplastic materials containing photoluminescent pigments, and, in particular to a thermoplastic material containing photoluminescent pigments having a light-reradiating surface that fits snugly over an electric lamp so that radiant energy from the electrical lamp is stored in the sleeve during normal operation of the electric lamp and that the photoluminescent sleeve reradiates light by for many days when the electric lamp is extinguished.

Photoluminescent materials absorb and store light energy when they are illuminated by visible light or invisible electromagnetic (EM) radiation (such as ultraviolet or infrared EM radiation) light propagating from an excitation source of illumination, and then reradiate the stored energy as visible or invisible light. The amount of reradiated light decreases exponentially over time when the excitation source of illumination is removed.

Building codes and regulations for ships, vehicles, passenger transportation systems, mines and other spaces require that exit routes be lighted continuously during occupation to permit safe egress at all times. Backup power sources such as batteries and petroleum-fueled generators are usually employed to ensure these requirements are met when normal power to the lighting fails. These systems have the disadvantage that they do not necessarily ensure that occupants will be able to see the way out if the normal building or passenger transporting vehicle power is interrupted. For example, fire can damage a centrally located power source, related distribution and transfer systems, and fuel storage. Batteries can fail as they expire over a period of time. Effective emergency lighting systems are expensive to purchase, install and to maintain, requiring building or transportation maintenance and management practices that are not always implemented. When emergency lighting systems fail during emergencies, the efficiency of building or transportation evacuation can be impaired. This can contribute to panic and loss of life, and physical and psychological injury.

Alternative and supplemental methods of emergency lighting include linear path marking systems that are designed to overcome some of the above problems. Linear path marking systems involve narrow lengths of light sources attached to the walls, floors, and/or other architectural features of evacuation routes so that, in darkness, the path to safety remains evident. They can include photoluminescent pigments that store energy when they are illuminated by visible or invisible (i.e. ultraviolet or infrared) external light propagating from an excitation source of illumination and then release it as visible light, in decreasing intensity over a period of time during subsequent darkness. Supplemental linear path marking systems are required for some types of buildings in some jurisdictions including the State of California. They are also required on passenger ships (i.e. IMO Resolution A. 752(18) as well as, passenger trains APTA SS-PS-004-99. These systems are expensive and cannot be installed then relocated or removed without damaging the building surface or transportation vehicles, trains or ships. The usefulness of photoluminescent linear path marking systems depends upon how the illumination light propagating excitation source is arranged to keep them charged. Objects that might shade the photoluminescent pigments from the illumination light propagating excitation sources that are intended to keep them charged in a building, transportation vehicle, train, or ship can compromise the usefulness of these systems.

Another limitation of photoluminescent path marking systems is that they do not emit sufficient light to effectively illuminate other surfaces by reflection of light from them. Consequently, in darkness, objects including obstacles cannot be seen unless photoluminescent material is applied to them directly.

As can be seen, there is a need for an improved photoluminescent apparatus that may be conveniently energized during times of adequate electric power and that can provide a continued light source during times of reduced or no electric power.

### SUMMARY OF THE INVENTION

In one aspect of the present invention, a lamp comprises a sleeve fitting over at least a portion of the lamp; a photoluminescent pigment being contained in the sleeve; the photoluminescent pigment storing radiant energy from the lamp during illumination; and the photoluminescent pigment releasing the stored radiant energy during a period when the lamp is not illuminated.

In another aspect of the present invention, a lamp comprises a sleeve, made of a translucent thermoplastic material, fitting over at least a portion of the lamp; a photoluminescent pigment being contained in the sleeve; the photoluminescent pigment storing visible light or invisible EM radiation from the lamp during illumination without requiring the presence of an external light source; the photoluminescent pigment releasing stored visible light or invisible EM radiation during a period when the lamp is not illuminated.

In yet another aspect of the present invention, a fluorescent lamp comprises a sleeve, made of a translucent thermoplastic material, fitting over the lamp; a photoluminescent pigment being contained in the sleeve; the photoluminescent pigment storing visible light or invisible EM radiation from the fluorescent lamp during illumination without requiring the presence of an external light source; the photoluminescent pigment releasing stored visible light or invisible EM radiation during a period when the fluorescent lamp is not illuminated; an end cap for securing the sleeve onto the fluorescent lamp, said end cap having an aperture therethrough to pass through bi-pin electrical connectors of the fluorescent lamp; a space between the sleeve and the fluorescent lamp; and the sleeve transmitting at least 60% of the visible light or invisible EM radiation that is emitted by the lamp during illumination.

In a further aspect of the present invention, a lamp comprises storing means for accumulating radiant energy from the lamp when the lamp is electrically illuminated, the storing means including a sleeve fitting over the lamp; and securing means for positioning the sleeve near the lamp; wherein light emitted from the lamp when the lamp is electrically illuminated travels unobstructed from the lamp to the storing means.

In still a further aspect of the present invention, a method for providing emergency lighting, comprises combining a thermoplastic translucent material with a photoluminescent pigment; fitting the thermoplastic translucent material over at least a portion of a lamp; storing visible light or invisible EM radiation in the thermoplastic translucent material from the lamp during illumination without requiring the presence of an external light source; releasing stored visible light or invisible EM radiation during a period requiring emergency lighting.

In describing the present invention, the term “photoluminescent material” refers to any material that absorbs and stores energy when illuminated by visible light or invisible EM radiation that later radiates the stored energy as visible light or invisible EM radiation. A typical example of a photoluminescent material is a suspension of strontium aluminate in a plastic binder that is formed into sheets, films or injection molded or extruded.

The term “luminaire” means an implement or device that will emit light.

All other terms not defined herein have their common-art recognized meanings.

These and other features, aspects and advantages of the present invention will become better understood with reference to the following drawings, description and claims.

### BRIEF DESCRIPTION OF THE DRAWINGS

FIG. 1 is a schematic depiction of a lamp according to one embodiment of the present invention;

FIG. 2 shows a cross-sectional view of one end of the lamp of FIG. 1; and

FIG. 3 shows an end view of an end cap used in the lamp of FIG. 2.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides an electric lamp that may be a reliable and inexpensive secondary source of light when electric power to the electric lamp is lost. Novel linear path marking systems may be developed by fitting a series of electric lamps, for example, along the length of the exit path, with a photoluminescent sleeve that may then be used as a secondary source of light when the electric lamp is extinguished due to a power disruption. Moreover, energy saving general lighting devices may include a photoluminescent sleeve located at or near an electric light source. For example, a lamp shade may be designed having a photoluminescent film that may reradiate light when power is reduced to the electric lamp.

Applications for the Invention include emergency lighting systems, both overhead and low level (i.e. near the floor), general lighting systems, and supplemental lighting systems. A preferred application of the present invention is in emergency lighting systems. A further advantage of the present invention is that, unlike battery-powered emergency lighting systems, no replacement of expired batteries or maintenance or systematic checking of the batteries is required. This is a very desirable characteristic for most emergency lighting systems during an emergency electric disruption.

Conventional emergency lighting requires a battery or alternative energy source to power the electric lamp. As noted above, such conventional emergency lighting requires special maintenance along with special delivery of the backup electric power (battery, generator and the like) to the electric lamp. Emergency lighting using the design of the present invention has the advantage that it is substantially maintenance free and eliminates the human factor in an evacuation/emergency lighting system.

The present invention overcomes the problems associated with expensive and unreliable conventional emergency lighting practices by creating a photoluminescent product that can reliably indicate the exit path and can illuminate nearby hazards when normal lighting systems fail. Other advantages: uses existing building equipment without affixing anything to the building surfaces. Yet another advantage of the invention is that the path marking system can be easily relocated without affecting the building surfaces.

The consensus of most lighting experts is that a visible exit pathway is the single most critical factor to saving lives in emergency situations. Every country in the world faces this problem with increasing pressure on building occupancy and transportation systems. The present invention makes it possible to provide a cost effective, flexible, reliable and portable emergency secondary light source.

In essence, the present invention taps into a previously inaccessible, renewable source of secondary light. The present invention has the economic advantage of eliminating high capital and energy costs to provide a safe, reliable source of secondary light in emergency situations and the need to provide illuminated failsafe exit pathways. The present invention also has the economic advantage of providing a general lighting system that may be used to reduce energy consumption. For example, a series of lamps at a large worktable, such as those found in a public library, may provide light by either an electric lamp, or by a lampshade (or other electric lamp covering) having the photoluminescent sleeve of the present invention. In this example, for every one lamp lit be electric power, there may be one adjacent lamp illuminated by reradiation of stored energy in the photoluminescent sleeve. Thus, at any given time, only half of the lamps are drawing electric current while all of the lamps remain illuminated.

The present invention is a translucent, preferably a nearly transparent, photoluminescent sleeve that fits over an electric lamp so that radiant energy is stored in the photoluminescent sleeve during normal operation of the lamp. The photoluminescent sleeve may then be capable of reradiating the stored energy as visible light or invisible EM radiation. The present invention provides a low cost failsafe secondary light source in emergency situations that will operate in all conditions as compared with those conventional emergency lighting practices that rely on emergency power sources.

The design of the present invention maximizes the efficiency of the photoluminescent pigments, measured in terms of time to charge the photoluminescent pigments, decay time of the photoluminescent pigments in darkness and, the brightness of the photoluminescent pigments in darkness. This is accomplished by ensuring that the photoluminescent pigments remain as close as possible to the source of light and heat without affecting greatly, the photometric, spectrophotometric, and thermal properties of the electrical lamp. The high photoluminescent illumination output of the present invention enables the lamp to illuminate other nearby objects by reflection of this light.

The design of the present invention ensures that the charging (i.e. storage of the radiant energy from the illuminated lamp) of the photoluminescent pigments cannot be compromised by the placement of other objects between the light source and the photoluminescent pigments. This increases the reliability of emergency lighting systems.

The present invention is useful in that it may increase safety and confidence of occupants when conventional electrical lighting and emergency lighting fails. Its performance does not depend upon how luminaires and other objects are placed in the occupied space, thus overcoming the barriers to the implementation of effective codes and standards on emergency lighting that employ photoluminescent technology.

An advantage of the present invention is that it may be implemented in areas where it is not possible to install other emergency lighting systems at a reasonable cost.

The present invention may use photoluminescent materials to circumvent the problem with conventional emergency lighting systems using centrally located power sources can fail when fire damages the power source or distribution system.

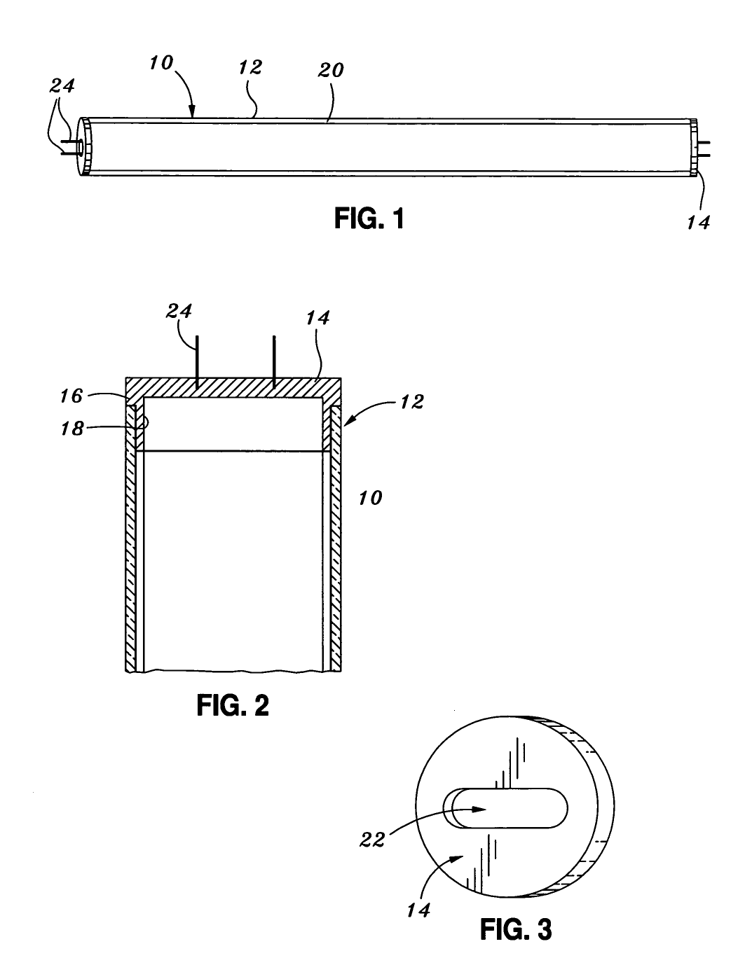

Referring to FIGS. 1 and 2, there is shown an embodiment of the present invention using a fluorescent lamp 10 having a photoluminescent sleeve 12.

Photoluminescent sleeve 12 may be formed of thermoplastic materials containing photoluminescent pigments as the absorption and storage of light energy when illuminated by visible light or invisible EM radiation propagating from an excitation source of illumination such as lamp 10. The amount of reradiated light decreases exponentially over time when the excitation source of illumination is removed. Preferably, photoluminescent sleeve 12 is a nearly transparent sleeve, having at least 60% overall transmittance, that is designed to be fit snugly over lamp 10. Preferably, the photoluminescent pigments in photoluminescent sleeve 12 may store radiant energy from lamp 10 and other illumination sources when lamp 10 is electrically charged. When electric power to lamp 10 is reduced or absent photoluminescent sleeve 12 emits light by photoluminescence that may be visible for as long as 7 days after lamp 10 and all other illumination sources are extinguished.

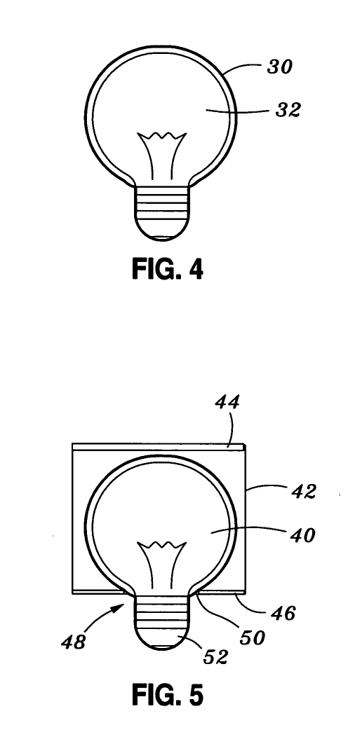

Referring now to FIG. 3, end caps 14 may be provided to secure photoluminescent sleeve 12 around lamp 10. Preferably, end caps 14 have a larger diameter portion 16 and a smaller diameter portion 18. Photoluminescent sleeve 12 may have an inside diameter sized to fit smaller diameter portion 18 therein, but be sized too small to fit larger diameter portion 16. Thus, end cap 14 may provide an annular space 20 around lamp 10 to allow air to circulate around lamp 10 at all times, thereby avoiding overheating of lamp 10. End caps 14 of the photoluminescent sleeve 12 may have an aperture 22 to enable an electrical connection, such as a bi-pin electrical connectors 24 of lamp 10 to protrude through end caps 14 so as to enable them to be inserted in the sockets of an electrical lamp fixture (not shown). Smaller diameter portion 18 is preferably sized to frictionally fit inside of photoluminescent sleeve 12, thereby securing photoluminescent sleeve 12 to lamp 10. To help hold end cap 14 in place, smaller diameter portion 18 and/or photoluminescent sleeve 12 may contain ridges or threads (not shown) at their boundary when assembled 24.

Preferably, photoluminescent sleeve 12 is a tubular, linear, continuous, seamless hollow tube made of thermoplastic material containing photoluminescent pigments. Photoluminescent sleeve 12 may be manufactured by extrusion or injection molding of a clear thermoplastic materials containing photoluminescent pigments.

While the present invention has been described using a linear, tubular fluorescent lamp, other shapes (circular, round, irregular and the like) and types of lamps (e.g, incandescent, metal halide) may be used in the present invention. Likewise, other transparent or translucent substrates such as glass may be considered suitable alternatives to said thermoplastic material. While the present invention has been described using a solid photoluminescent sleeve 12, perforations of different shapes may be made in photoluminescent sleeve 12 to improve transmission of light and heat therethrough during the normal operation of lamp 10. A reflective material (not shown) may be co-extruded or otherwise laminated or applied on the inside of photoluminescent sleeve 12 to improve the reflection of the secondary light emitted from photoluminescent sleeve 12 when lamp 10 is non operational.

Referring to FIG. 4, there is shown an alternate embodiment of the present invention. While the above embodiment of FIGS. 1-3 describes a thermoplastic sleeve surrounding a fluorescent tube lamp with a space between the sleeve and the lamp, other embodiments may be envisioned within the scope of the present invention. For example, the photoluminescent material may be made part of a thermoplastic liquid, such as a self-rigidizing substantially transparent epoxy 30. Epoxy 30 may be dip coated directly onto a surface of a lamp, such as an incandescent light bulb 32. The resulting light bulb 32 may then be imparted with photoluminescent properties similar to that of the fluorescent tube described in the previously described embodiment.

Alternatively, referring to FIG. 5, an incandescent light bulb 40 may be at least partially fitted into a tube 42 having a photoluminescent material coextruded therewith or coated thereupon. Tube 42 may have one solid top side end cap 44 and one electrical connection side end cap 46. End caps 44 and 46 preferably fit into tube 42 with a friction fit. Electrical connection side end cap 46 may be designed with a hole 48 to allow a base 52 of incandescent light bulb 40 to fit there through. Hole 48 in electrical connection side end cap 46 preferably may be cut in three sizes to accommodate the three base sizes of incandescent light bulb 40 (candelabra, medium and mogul). A rubber o-ring 50 may be installed around the inside diameter of hole 48 to provide support for tube 42. Optionally, hole 48 may be threaded to match the threads of base 52, thereby allowing electrical connection side end cap 46 to thread on base 52.

It should be understood, of course, that the foregoing relates to preferred embodiments of the invention and that modifications may be made without departing from the spirit and scope of the invention as set forth in the following claims.

1. A lamp comprising:
a sleeve fitting over at least a portion of said lamp;
a photoluminescent pigment being contained in said sleeve;
said photoluminescent pigment storing radiant energy from said lamp during illumination; and
said photoluminescent pigment releasing said stored radiant energy during a period when said lamp is not illuminated.

2. The lamp according to claim 1, further comprising an end cap for securing said sleeve onto said lamp.

3. The lamp according to claim 1, wherein said sleeve is made of a thermoplastic material having transparent or translucent properties.

4. The lamp according to claim 1, wherein said radiant energy is either visible light or invisible electromagnetic radiation.

5. The lamp according to claim 1, wherein said sleeve fits over the entirety of said lamp.

6. The lamp according to claim 1, wherein said sleeve includes perforations that communicate ambient air to a surface of said lamp.

7. The lamp according to claim 1, further comprising a space between said sleeve and said lamp.

8. The lamp according to claim 1, wherein said sleeve transmits at least 60% of the light that is emitted by said lamp during illumination.

9. The lamp according to claim 1, wherein said photoluminescent pigment stores radiant energy from said lamp during illumination without requiring the presence of an external light source.

10. The lamp according to claim 3, further comprising a reflective substrate co-extruded with said thermoplastic material, thereby enhancing the release of said stored radiant energy during a period when said lamp is not illuminated.

11. The lamp according to claim 1, wherein said lamp is in the form of a fluorescent tube.

12. The lamp according to claim 1, wherein said lamp is in the form of an incandescent bulb.

13. The lamp according to claim 1, wherein said sleeve is formed directly on an exterior surface of said lamp.

14. The lamp according to claim 1, wherein said sleeve is coated onto a surface detached from an exterior surface of said lamp.

15. The lamp according to claim 15, wherein said surface is a lamp shade.

16. A lamp comprising:
a sleeve, made of a translucent material, fitting over at least a portion of said lamp;
a photoluminescent pigment being contained in or on said sleeve;
said photoluminescent pigment storing visible light or invisible electromagnetic radiation from said lamp during illumination without requiring the presence of an external light source;
said photoluminescent pigment releasing stored visible light or invisible electromagnetic radiation during a period when said lamp is not illuminated.

17. The lamp according to claim 16, wherein said sleeve includes perforations that communicates ambient air to a surface of said lamp.

18. The lamp according to claim 16, wherein:
said sleeve transmits at least 60% of said visible light or invisible electromagnetic radiation that is emitted by said lamp during illumination; and
said sleeve fits over the entirety of said lamp.

19. The lamp according to claim 16, further comprising:
an end cap for securing said sleeve onto said lamp;
a space between said sleeve and said lamp.

20. The lamp according to claim 16, further comprising a reflective substrate co-extruded with said thermoplastic material, thereby enhancing the release of said stored radiant energy during a period when said lamp is not illuminated.

21. A fluorescent lamp comprising:
a sleeve, made of a translucent thermoplastic material, fitting over said lamp;
a photoluminescent pigment being contained in or on said sleeve;
said photoluminescent pigment storing visible light or invisible electromagnetic radiation from said fluorescent lamp during illumination without requiring the presence of an external light source;
said photoluminescent pigment releasing stored visible light or invisible electromagnetic radiation during a period when said fluorescent lamp is not illuminated;
an end cap for securing said sleeve onto said fluorescent lamp, said end cap having an aperture therethrough to pass through electrical connectors of said fluorescent lamp;
a space between said sleeve and said fluorescent lamp; and
said sleeve transmitting at least 60% of said visible light or invisible electromagnetic radiation that is emitted by said lamp during illumination.

22. The fluorescent lamp according to claim 21, wherein:
said fluorescent lamp is tubular and linear;
said sleeve is tubular, concentrically fitting around said fluorescent lamp; and
said space is an annulus formed even around said fluorescent lamp.

23. The fluorescent lamp according to claim 21, further comprising a reflective substrate co-extruded with or applied to said thermoplastic material, thereby enhancing the release of said stored radiant energy during a period when said fluorescent lamp is not illuminated.

24. The fluorescent lamp according to claim 21, wherein said sleeve includes perforations that communicates ambient air to a surface of said lamp.

25. A lamp comprising:
storing means for storing radiant energy from said lamp when said lamp is electrically illuminated, said storing means including a sleeve fitting over said lamp; and
securing means for positioning said sleeve near said lamp;
wherein light emitted from said lamp when said lamp is electrically illuminated travels unobstructed from said lamp to said storing means.

26. The lamp according to claim 25, wherein said sleeve contains photoluminescent pigments

27. A sleeve capable of fitting over at least a portion of a lamp comprising:
a photoluminescent pigment being contained in or attached to a surface of said sleeve;
said photoluminescent pigment storing radiant energy from said lamp during illumination; and
said photoluminescent pigment releasing said stored radiant energy during a period when said lamp is not illuminated.

28. The sleeve according to claim 27, wherein said sleeve is made of a thermoplastic material having transparent or translucent properties.

29. The lamp according to claim 27, further comprising:
perforations that communicate ambient air to a surface of said lamp; and
a space between said sleeve and said lamp.

30. The lamp according to claim 27, wherein said sleeve transmits at least 60% of the light that is emitted by said lamp during illumination.

31. The lamp according to claim 27, wherein said photoluminescent pigment stores radiant energy from said lamp during illumination without requiring the presence of an external light source.

32. The lamp according to claim 27, further comprising a reflective substrate between said lamp and said sleeve, thereby enhancing the release of said stored radiant energy during a period when said lamp is not illuminated.

33. A method for providing emergency lighting, comprising:
combining a thermoplastic translucent material with a photoluminescent pigment;
fitting said thermoplastic translucent material over at least a portion of a lamp;
storing visible light or invisible electromagnetic radiation in said thermoplastic translucent material from said lamp during illumination without requiring the presence of an external light source; and
releasing stored visible light or invisible electromagnetic radiation during a period requiring emergency lighting.

34. The method according to claim 33, further comprising perforating said thermoplastic translucent material to communicates ambient air to a surface of said lamp.

35. The method according to claim 33, further comprising:
allowing at least 60% of said visible light or invisible electromagnetic radiation that is emitted by said lamp during illumination to pass through said thermoplastic translucent material; and
fitting said sleeve over the entire surface of said lamp.

36. The method according to claim 33, further comprising:
securing said sleeve onto said lamp with an end cap; and
providing a space between said sleeve and said lamp.

37. The method according to claim 33, further comprising enhancing the release of said stored radiant energy during a period when said lamp is not illuminated by co-extruding a reflective substrate with said thermoplastic material.
